(19) United States
(12) Patent Application Publication
(10) Pub. No.: US 2017/0225801 A1
(43) Pub. Date: Aug. 10, 2017

(54) Drone support and operations system

(71) Applicant: Douglas Bennett, Cary, NC (US)

(72) Inventor: Douglas Bennett, Cary, NC (US)

(21) Appl. No.: 15/018,580

(22) Filed: Feb. 8, 2016

(51) Int. Cl. B64F 1/22; G05D 1/06; B64C 39/02; B64F 1/00; B64F 1/18

(52) U.S. Cl. CPC B64F 1/222; B64F 1/005; B64F 1/18; B64C 39/024; G05D 1/0676; B64C 2201/108; B64C 2201/104; B64C 2201/145

(57) ABSTRACT

Systems and methods for drone support and operation are provided. The system for providing support includes a base with at least one docking area and a cover portion configured to move between an open and closed position and a drone support unit configured to provide support for the drone at least during the time the drone is in the at least one docking area of the base.

### TECHNICAL FIELD

This invention generally relates to drones, and more particularly, to systems and methods for operating and providing support for drones.

### BACKGROUND

Drones and other types of unmanned vehicles have become increasingly popular over the past several years. Drones have been used to perform search-and-rescue missions, monitor inventory at construction sites, gather intelligence regarding crops, or simply for entertainment and recreational purposes.

These drones, however, are typically reliant on human operators for operation. For example, operators may have to manually place a drone in a storage area after use, and manually remove the drone from the storage area before use. When not in use, these drones are typically isolated and receive no information regarding other drones, weather, tasks, and, depending on the storage area, may be at risk due to inclement weather or other external parameters.

A need exists, therefore, for systems and methods for providing support for at least one drone.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

In one aspect, embodiments of the present invention relate to a drone support system, the system comprising: a base including at least one drone docking area for receiving at least one drone; and a cover portion configured to move between an open position for providing access to the drone docking area and a closed position for obstructing access to the drone docking area; and a drone support unit configured to provide support to at least one drone at least during the time when the at least one drone is in the at least one docking area of the base.

In one embodiment of the drone support system, the cover portion is configured as a hinged portion or an irising portion.

In one embodiment of the drone support system, the cover portion is configured to move between the open position and the closed position autonomously.

In one embodiment of the drone support system, the base is configured to charge a power source of at least one drone during the time when the at least one drone is in the docking area. In this embodiment, the base may be configured to charge the power source of the at least one drone via induction or via direct contact with the at least one drone.

In one embodiment of the drone support system, the drone support unit is in operable communication with at least one drone and provides support by providing data to the at least one drone. In this embodiment, the data may include data related to one or more of weather, flying conditions, mission assignments, instructions, and data regarding at least one other drone.

In one embodiment of the drone support system, the base further includes at least one heating element to provide heat or at least one cooling element to provide cooling.

In one embodiment of the drone support system, the base is configured to be powered by batteries or via a wired connection to an external power source.

In one embodiment of the drone support system, the base is configured to receive a plurality of different types of drones, including fixed wing drones and multiple rotary drones.

In one embodiment of the drone support system, the base is configured to receive a plurality of drones of different sizes.

In another aspect, embodiments of the present invention relate to a system for operating at least one drone, the system comprising at least one drone; a base, wherein the base includes at least one drone docking area for receiving the at least one drone and a cover portion configured to move between an open position for providing access to the drone docking area and a closed position for obstructing access to the drone docking area; and a drone support unit in operable communication with the at least one drone to provide support for the at least one drone at least during the time when the at least one drone is in the at least one docking area of the base.

In one embodiment of the system for operating the at least one drone, the at least one drone is configured to take off from the drone docking area autonomously.

In one embodiment of the system for operating the at least one drone, the at least one drone is configured to land in the drone docking area autonomously.

In one embodiment of the system for operating the at least one drone, the at least one drone includes one or more of a light sensor device, a visual indicia sensor device, an infrared sensor device, a sonar device, and a global positioning system to at least assist the drone in landing in the drone docking area.

In one embodiment of the system for operating the at least one drone, the drone support unit is configured as part of the base.

In one embodiment of the system for operating the at least one drone, the drone support unit is at a location remote from the base.

In one embodiment of the system for operating the at least one drone, the at least one drone includes a smart power source for at least monitoring the at least one drone's power.

In yet another aspect, embodiments of the present invention relate to a method of providing support to at least one drone, the method comprising providing a drone base, wherein the drone base includes at least one docking area for at least receiving the at least one drone, and a cover portion configured to move between an open position for providing access to the drone docking area and a closed position for obstructing access to the drone docking area; opening the cover portion to enable at least one drone to enter the at least one docking area of the base; and providing, using a drone support unit, data to the at least one drone at least during the time the drone is in the docking area of the base, wherein the data includes data related to one or more of weather, flying conditions, mission assignments, instructions, and data regarding at least one other drone.

In yet another aspect, embodiments of the present invention may include a base that may be mounted to a structure such as a wall or a post. In this particular embodiment, the base may include an entrance at the bottom of the base such that a drone may enter and fly up into the base, and then move forward to land on a shelf portion. The base in this embodiment may include a cover portion in the form of a flap at the entrance of the base that may open to at least allow a drone to enter and exit the base.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 schematically illustrates components of a drone support system in accordance with one embodiment;

FIG. 2 illustrates a perspective view of a base in accordance with one embodiment;

FIG. 3 illustrates another perspective view of the base of FIG. 2 with a cover portion in an open position;

FIG. 4 illustrates a top view of the base of FIG. 2;

FIG. 5 illustrates a top view of a base in accordance with another embodiment;

FIG. 6 illustrates a top view of a base in accordance with yet another embodiment;

FIG. 7 illustrates a system for operating a drone in accordance with one embodiment;

FIG. 8 depicts a flowchart of a method of providing support to at least one drone in accordance with one embodiment; and

FIG. 9 illustrates a side view of a base in accordance with another embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

FIG. 1 schematically illustrates a drone support system 100 in accordance with one embodiment of the invention. The system 100 may include a base 102 and a drone support unit 104 for providing support for at least one drone. In the context of the present application, the term “drone” may refer to any unmanned aerial vehicle.

The base 102 may serve as a hangar and may include at least one docking area 106 for receiving a drone when the drone is not in flight. The docking area 106 may include a landing pad, for example.

The base 102 may also include a cover portion 108 for providing access to the base 102, namely, the docking area 106. The cover portion 108 may be configured to move, via a movement mechanism 110, between an open position for providing access to the drone docking area (e.g., so a drone can land in the drone docking area and/or take off from the drone docking area) and a closed position for obstructing access to the drone docking area (e.g., to protect a drone within the base 102).

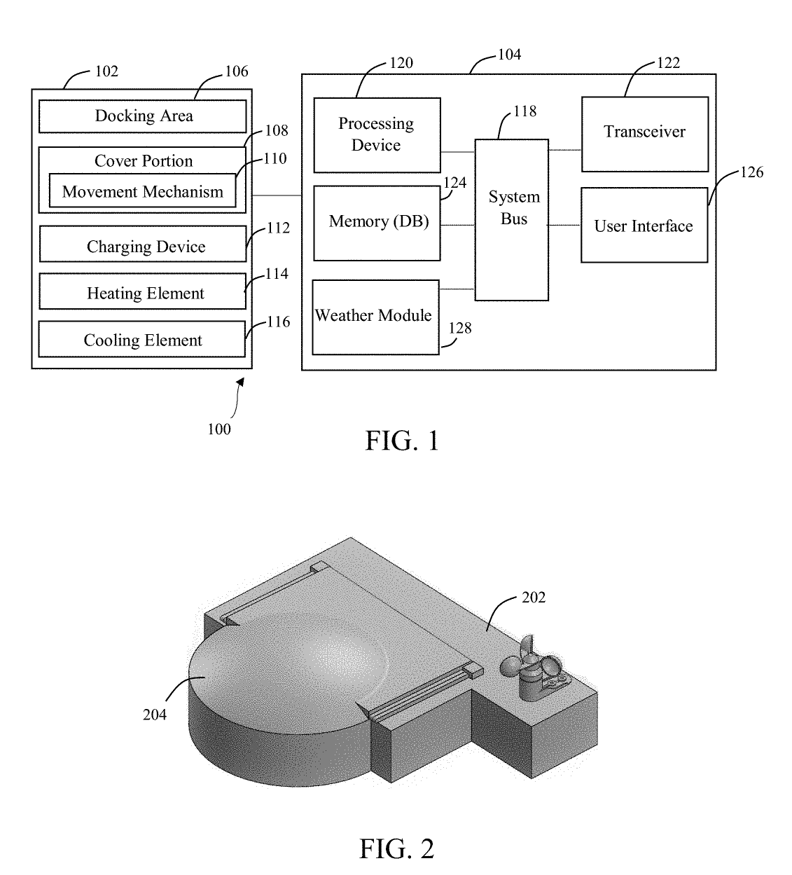

FIG. 2, for example, shows an exemplary base 202 in accordance with one embodiment of the invention. The base 202 includes a cover portion 204 that is seen in a closed position.

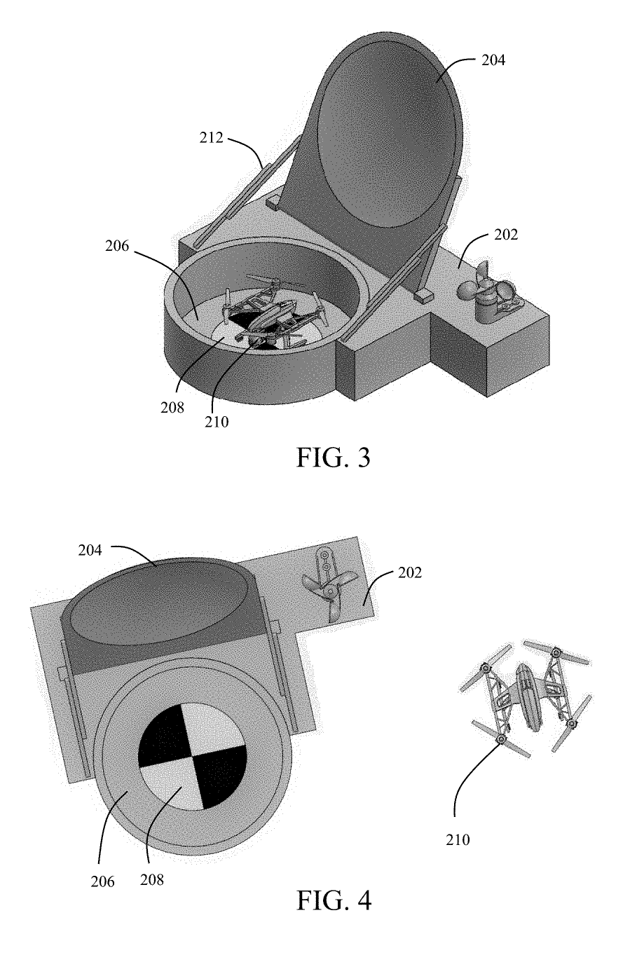

FIG. 3 shows the base 202 of FIG. 2 with the cover portion 204 in the open position, thereby exposing or otherwise enabling access the drone docking area 206. This embodiment of the base 202 may be referred to as a “clam-shell” configuration, and the cover portion 204 is a hinged portion that moves between the open and closed positions. The drone docking area 206 may include a landing pad 208 for receiving at least one drone 210.

In various embodiments, the movement mechanism 212 may be in the form of any suitable means such as a system of hydraulic or pneumatic actuator devices. The movement mechanism 212 may also include a motorized system of gears, servos, telescoping devices, or the like to move the cover portion 204 between the open and closed positions.

FIG. 4 shows a top view of the base 202 of FIGS. 2 and 3 with the cover portion 204 in the open position. FIG. 4 also shows the drone docking area 206 while the drone 210 is in flight. In this case, the drone 210 is a multi-rotary drone, however, other types of drones such as fixed-wing drones may be used in conjunction with the features of the invention.

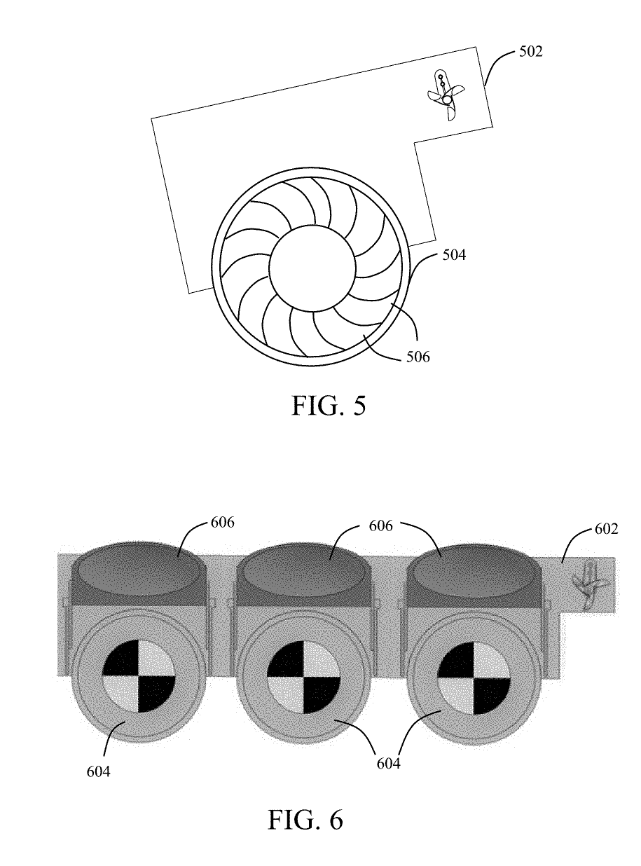

FIG. 5 shows a top view of a base 502 in accordance with another embodiment. In this embodiment the cover portion 504 may be an irising portion defined by a plurality of blade portions 506. As the blade portions 506 extend, access to the drone docking area is effectively obstructed. When the blade portions 506 retract, access to the drone docking area is enabled.

FIG. 6 shows a top view of a base 602 in accordance with another embodiment. In this embodiment, the base 602 includes multiple docking areas 604, each area including its own cover portion 606. The base 602 can therefore accommodate multiple drones. It is also contemplated that a single docking area may be large enough to accommodate multiple drones in a single docking area instead of having one drone per docking area.

Returning to FIG. 1, the base 102 may also include a charging device 112 for charging a power source of a drone when the drone is in the base 102. The configuration of the charging device 112 may vary and may depend on the type of power source of the drone.

For example, the charging source 112 may be configured to provide power to a drone wirelessly, such as through induction, or through physical contact, e.g., using exposed metal or other conductive material surfaces that conduct power through physical contact. There may be a charger on the base 102 such that, as soon the drone is in the docking area 106, it wirelessly charges for the drone. Similarly, the charging source 112 may charge the power source of a drone via hardwired connection.

The base 102 may also include at least one heating element 114 and/or at least one cooling element 116. The heating element 114 may provide heat within the base 102, namely, the docking area 106 to keep a drone at a controlled temperature while in the base 102 (e.g., if the base is located in a cold environment). The cooling element 116 may cool the docking area 106 to keep a drone at a controlled temperature while in the base 102 (e.g., if the base 102 is located in a warm environment). The base 102 itself may be powered by batteries or via a connection with an external power source.

The drone support unit 104 may include a plurality of components to provide support for at least one drone. In the context of the present application, the term “support” may include navigational support, functional support, informational support, instructions, or other types of support to assist at least one drone in functioning, performing tasks, or the like.

The drone navigation support unit 104 may be implemented as part of the base 102 or may be at a location remote from the base 102. The drone support unit 102 may include at least one system bus 118 to enable communication between a processing device 120 and a plurality of other components.

The processing device 120 may be implemented as any configured processor that is able to receive and process information related to drone support. The processing device 120 may also communicate electrical control signals to appropriate components to support a drone accordingly. The processing device 120 may be in communication with any or all of the components of the drone support unit 104 via any wireless or hardwired connection.

The drone support unit 104 may communicate with at least one drone (not shown in FIG. 1) via at least one transceiver 116. This communication may be made by any wireless means (e.g., to enable communication when a drone is in flight or otherwise not in the base). The communication may also be made via any hardwired connection to enable communication such as when the drone is in the base 102. Additionally, a drone may be tethered to the drone support unit 104 or other apparatus to “fly-by-wire” in which communications, power, and other electronic or video data or signals may be transmitted by wire rather than wirelessly.

The drone support unit 104 may further include a memory 124 including L1, L2, L3 cache or RAM memory configurations. The memory 124 may be include non-volatile memory such as flash memory, EPROM, EEPROM, ROM, and PROM, or volatile memory such as static or dynamic RAM, as discussed above. The exact configuration/type of memory 124 used may of course vary as long as information can be stored and retrieved to accomplish the features of various embodiments of the invention.

The memory 124 may store instructions and other information related to drones. For example, the memory 124 may store information relating to drone tasks and operational parameters, such as optimal flight speed and altitude for a drone.

The user interface 126 may be in communication with the processing device 120 and receive instructions from and/or present information to an operator. The user interface 126 may be implemented in the form of a smartphone, tablet, PC monitor, laptop monitor, or the like. The user interface 126 may be configured as part of the base 102 or implemented separately from the base 102.

The user interface 126 may allow an operator or another interested party to monitor the status of any drones, control the cover portion 108 of the base 102 (e.g., open the cover portion 108 or close the cover portion 108), or provide instructions. For example, an operator may input commands instructing a particular drone to gather surveillance of a certain path or location.

The weather module 128 may monitor information related to the weather outside of the base 102 and/or at other locations. The weather module 128 may monitor the weather in real time, communicate information related to the weather to the processing device 120 so that the processing device 120 can make fly/no-fly decisions and communicate those decisions to a drone.

For example if the temperature is above or below a certain temperature that may be harmful for a drone to operate in, the processing device 120 may prevent a drone from taking off from the base 102. Factors related to the weather that may impact whether a drone is able to fly include, but are not limited to, precipitation (rain, snow, hail, etc.), wind, temperature, humidity, air pressure, lightning, and visibility, among other factors.

The weather module 128 may also communicate information relating to future forecasts, so that the processing device 120 may instruct a drone(s) accordingly. For example, if severe weather (e.g., heavy rain accompanied by lightning and thunder) is predicted to occur in a certain area, the processing device 120 may instruct all drones in the area to return to the base 120.

The processing device 120 may also be in communication with the movement mechanism 110 of the base 102 to control the cover portion 108. For example, the processing device 120 may autonomously control if/when the cover portion 108 moves between the open and closed positions.

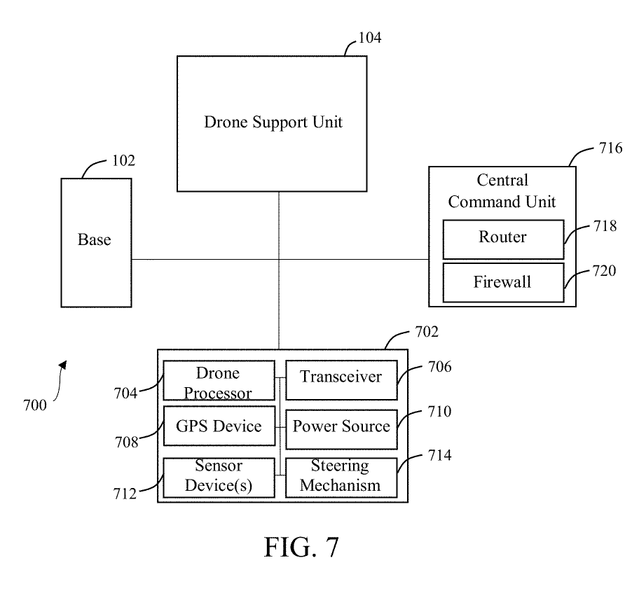

FIG. 7 illustrates a system 700 for operating a drone in accordance with one embodiment of the invention. The system 700 may include a base 102 and drone support unit 104 such as those in FIG. 1.

The system 700 may further include a drone 702. The drone 702 may be configured in a variety of sizes, and may be a multi-wing drone, a fixed wing drone, or other types of drones. The size and configuration of the drone 702 may vary as long as the features of the invention may be accomplished.

The drone 702 may include a drone processor 704, a transceiver 706, a global positioning system (GPS) device 708, a power source 710, at least one sensor device 712, and a steering mechanism 714.

The drone processor 704 may be implemented as any specially configured processor as long as it is able to receive and process information related to drone operation. The drone processor 704 may also communicate electrical control signals to appropriate components to enable the drone 702 to function accordingly. The drone processor 704 may be in communication with any or all of the components of the drone 702 via any wireless or hardwired connection.

The transceiver 706 may receive information from and communicate information to the drone support unit 104 via any suitable wireless method. The transceiver 706 may receive, for example, instructions from the drone support unit 104 such as to return to the base 102 because of incoming inclement weather. The transceiver 706 may also receive information relating to locations of other drones, instructions to gather surveillance of a certain area, or the like. This information may be communicated to the drone processor 704 to operate the drone accordingly.

The GPS device 708 may be in communication with one or more satellites to monitor the drone's location. The base 102 and the cover portion's movement mechanism 110 may be configured to open the cover portion 108 autonomously once the drone is within a predetermined distance from the base 102, for example.

The power source 710 may include at least one battery device such as a lithium polymer battery, for example. Whatever the exact configuration of the power source, it is preferable that the power source can be charged while the drone is in the docking area of the base. The power source 710 may be a “smart” power source that monitors its power level such that the drone 702 returns to the base 102 for charging without any outside instructions.

The drone 702 may further include at least one sensor device 712 for at least gathering information regarding the environment surrounding the drone 702. These sensor devices 712 may include sonar devices, charge-coupled device cameras, infrared camera devices, LIDAR devices, stereoscopic cameras, or the like.

The drone processor 704 may further include any computer vision analysis tools to process the information regarding the environment surrounding the drone 702 accordingly. For example, these analysis tools may recognize visual indicia such as markings on the base 102 and/or docking area 106 to assist in maneuvering. Any or all of these sensor device(s) 712 may, by themselves or in combination with the GPS device 708, help guide and navigate the drone 702.

The steering mechanism 714 may essentially control the movement of the drone 702. The configuration of the drone 702 may vary and the steering mechanism 714 may include one or more rotor devices, for example.

It is also contemplated that the base 102 may include one or more of these components. The base 102 may include a transceiver, GPS devices, sensor devices (e.g., sonar devices, charge-coupled device cameras, infrared camera devices, LIDAR devices, stereoscopic cameras) to assist the drone 702 in operation.

The positioning and telemetry of the drone 702 can be done off board in the base 102, onboard by the drone 702 or a combination of both. In one embodiment, the base 102 may transmit instructions to the drone 702 as the drone 702 attempts to land in the docking area. For example, the drone 702 may use its onboard GPS device 708 to get close to the base 102. Once within a predetermined distance of the base 102, the drone 702 may switch to a “visual mode” to look for patterns or other visual indicia near, in, or on the base 102, and then switch to sonar as it gets even closer to the base 102. As the drone 702 is transitioning through these modes, the base 102 may also provide the drone 702 with instructions for positioning as a dual approach.

FIG. 7 also illustrates a central control unit 716 with a router 718 and firewall 720. The central control unit 716 may be a device or a cloud-based system that may communicate and provide instructions directly to a drone (e.g., without utilizing the base 102 or drone support unit 104).

For example, the central control unit 716 may be an artificial intelligence cloud-based system that may command all drones in a small or large geographic area. The drone or drones may communicate directly through the router 718 and firewall 720, thereby providing a level of redundancy so that even if the base 102 or the drone support unit 104 were disabled while a drone is in the air, the drone can still function and receive instructions.

It is also contemplated that the central command unit 716 may perform any and all of the same functions performed by the drone support unit 104. For example, the central command unit 716 may monitor weather and provide fly/no fly decisions in real time. That is, communication may be established between the drone 702 and the base 102, the drone 702 and the drone support unit 104, the drone 702 and the central command unit 716, the base 102 and the central command unit 716, between the drone support unit 104 and the central command unit 716, or any combination thereof.

For instance, it may be more preferable for information from the drone 702 to go directly to the central command unit 716. For example, when the drone support unit 104 lacks a video buffer (or if the drone support unit 104 experiences a power or communication failure), video data obtained by the sensor devices 712 of the drone 702 may be communicated directly to the central command unit 716.

As mentioned previously, this configuration provides an extra layer of redundancy in the event communication between a drone and the base 102 or drone support unit 104 is unavailable or disrupted. It is also contemplated that drones can communicate with each other directly without requiring communication with the drone support unit 104 or the central command unit 716. For example, if a fleet of drones 702 are performing a mission assignment and one of them is inadvertently or intentionally disabled, the drones may communicate amongst themselves autonomously (and without receiving instructions from units 104 or 716) and reconfigure to complete the mission even in the absence of the disabled drone.

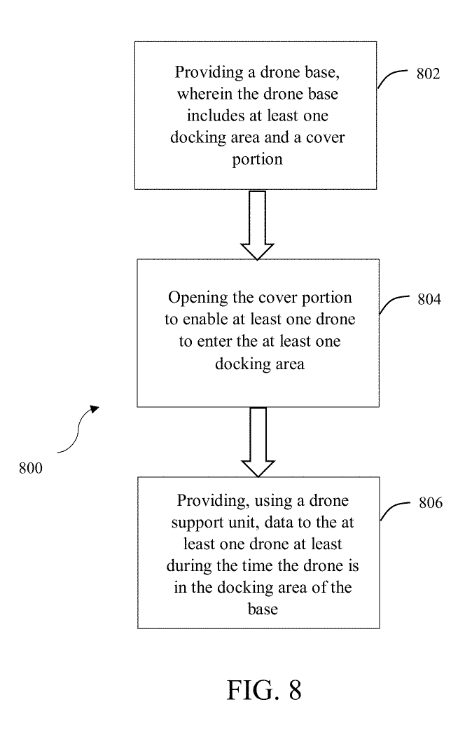

FIG. 8 depicts a flowchart of a method 800 of providing support to at least one drone. Step 802 involves providing a drone base. This base may be similar to the base 102 of FIGS. 1-6, and may include at least one docking area for at least receiving at least one drone, and a cover portion. The cover portion may be configured to move between an open position for providing access to the drone docking area and a closed position for obstructing access to the drone docking area.

Step 804 involves opening the cover portion to enable at least one drone to enter the at least one docking area of the base. The cover portion may be a hinged portion (e.g., similar to a “clam shell” configuration) or an irising portion, among other configurations. The cover portion may open autonomously, such as when it is detected that the drone is within a predetermined distance from the base.

Step 806 involves providing, using a drone support unit, data to the at least one drone at least during the time the drone is in the docking area of the base. The drone support unit may provide data to the at least one drone via any wireless method or wired connection when the drone is in the docking area, near the base, or in flight.

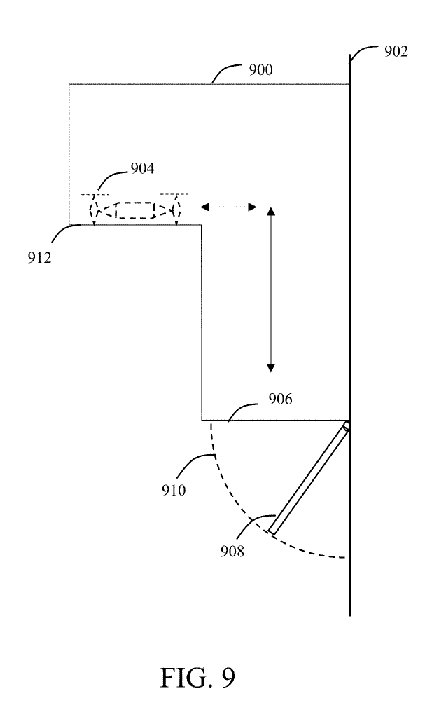

FIG. 9 illustrates a side view of a base 900 in accordance with another embodiment of the invention. In this embodiment, the base 900 may be mounted to a structure 902 such as a wall or a post.

According to this embodiment, drone 904 may enter the base 900 through an entrance 906 at the bottom of the base 900. The entrance 906 may be configured with a cover portion 908 in the form of a flap that may open along path 910 (indicated by the dashed lines). The cover potion 908 may of course be configured in other ways, such as an irising portion. Or, the base 900 may be configured without a cover portion.

The drone 904 may then fly up into the base 900 and then move forward (to the left, in FIG. 9, indicated by arrows) and then land on a drone docking area 912 in the form of a shelf portion. The base 900 in this embodiment may shelter the drone 900 and include any necessary components to provide support as in other embodiments described above.

The data provided to the drone may include information relating to weather, instructions, mission assignments (e.g., to gather surveillance from a certain area near the base), weather, and/or the locations of other drones and whether or not other drones are performing tasks.

In addition to mere data exchange, the base may provide other forms of support to the at least one drone. For example, if the drone had been operating in heat, a cooling element may provide cooling within the base (namely, the docking area) to help keep the drone at lower temperature. Alternatively, if the drone had been operating in colder temperatures, a heating element may provide warmth and keep the drone at a warmer temperature. The base may similarly provide protection from external environmental parameters when the drone is in the base (and the cover portion is in the closed positon, for example). The base may at least partially recharge a power source of the drone during the time the drone is in the base. It is also contemplated that base and the drones may be configured to withstand an intentional or natural induced electromagnetic energy pulse (EMP).

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A drone support system, the system comprising:
a base including:
at least one drone docking area for receiving at least one drone; and
a cover portion configured to move between an open position for providing access to the drone docking area and a closed position for obstructing access to the drone docking area; and
a drone support unit configured to provide support to at least one drone at least during the time when the at least one drone is in the at least one docking area of the base.

2. The drone support system of claim 1, wherein the cover portion is configured as a hinged portion or an irising portion.

3. The drone support system of claim 1, wherein the cover portion is configured to move between the open position and the closed position autonomously.

4. The drone support system of claim 1, wherein the base is configured to charge a power source of at least one drone during the time when the at least one drone is in the docking area.

5. The drone support system of claim 4, wherein the base is configured to charge the power source of the at least one drone via induction or via direct contact with the at least one drone.

6. The drone support system of claim 1, wherein the drone support unit is in operable communication with at least one drone and provides support by providing data to the at least one drone.

7. The drone support system of claim 6, wherein the data includes data related to one or more of weather, flying conditions, mission assignments, instructions, and data regarding at least one other drone.

8. The drone support system of claim 1, wherein the base further includes at least one heating element to provide heat or a cooling element to provide cooling.

9. The drone support system of claim 1, wherein the base is configured to be powered by batteries or via a wired connection to an external power source.

10. The drone support system of claim 1, wherein the base is configured to receive a plurality of different types of drones, including fixed wing drones and multiple rotary drones.

11. The drone support system of claim 1, wherein the base is configured to receive a plurality of drones of different sizes.

12. A system for operating least one drone, the system comprising:
at least one drone;
a base, wherein the base includes at least one drone docking area for receiving the at least one drone and a cover portion configured to move between an open position for providing access to the drone docking area and a closed position for obstructing access to the drone docking area; and
a drone support unit in operable communication with the at least one drone to provide support for the at least one drone at least during the time when the at least one drone is in the at least one docking area of the base.

13. The system of claim 12, wherein the at least one drone is configured to take off from the drone docking area autonomously.

14. The system of claim 12, wherein the at least one drone is configured to land in the drone docking area autonomously.

15. The system of claim 12, wherein the at least one drone or the base includes one or more of a light sensor device, a visual indicia sensor device, an infrared sensor device, a sonar device, and a global positioning system to at least assist the drone in landing in the drone docking area.

16. The system of claim 12, wherein the drone support unit is configured as part of the base.

17. The system of claim 12, wherein the drone support unit is at a location remote from the base.

18. The system of claim 12, wherein the at least one drone includes a smart power source for at least monitoring the at least one drone's power.

19. A method of providing support to at least one drone, the method comprising:
providing a drone base, wherein the drone base includes:
at least one docking area for at least receiving the at least one drone, and
a cover portion configured to move between an open position for providing access to the drone docking area and a closed position for obstructing access to the drone docking area;
opening the cover portion to enable at least one drone to enter the at least one docking area of the base; and
providing, using a drone support unit, data to the at least one drone at least during the time the drone is in the docking area of the base, wherein the data includes data related to one or more of weather, flying conditions, mission assignments, instructions, and data regarding at least one other drone.
